(19) United States
(12) Patent Application Publication
(10) Pub. No.: US 2004/0075728 A1
(43) Pub. Date: Apr. 22, 2004

(54) Feeding roller shaft supporter for ink-jet printer

(75) Inventors: Dong-Woo Ha, Suwon-city (KR); Myung-Bo Son, Anyang-city (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd, Suwon-city (KR)

(21) Appl. No.: 10/659,256

(22) Filed: Sep. 11, 2003

(30) Foreign Application Priority Data
Oct. 21, 2002 (KR) 2002-64350
Dec. 16, 2002 (KR) 2002-80509

(51) Int. Cl. B41J 2/01

(52) U.S. Cl. 347/104

(57) ABSTRACT

A feeding roller shaft supporter for an ink-jet printer having a feeding roller shaft, including a main chassis which forms a frame of an ink-jet printer; a first supporting unit in the main chassis supporting opposite ends of the feeding roller shaft; a driving member provided at a first end of the feeding roller shaft; an axial position correction unit mounted on the feeding roller shaft close to the driving member, correcting an axial position of the feeding roller shaft; and a second supporting unit supporting the feeding roller shaft, wherein the second supporting unit is provided on a second end of the feeding roller shaft, preventing the shaking of the feeding roller shaft caused by thrust when the feeding roller shaft rotates.

### CROSS-REFERENCE TO RELATED APPLICATIONS

This application claims the benefit of Korean Application Nos. 2002-64350, filed Oct. 21, 2002 and 2002-80509, filed Dec. 16, 2002, in the Korean Intellectual Property Office, the disclosures of which are incorporated herein by reference.

### BACKGROUND OF THE INVENTION

1. Field of the Invention

The present invention relates to an ink-jet printer, and, in particular, to a feeding roller shaft supporter for an ink-jet printer, which rotatably supports a feeding roller shaft for feeding printing paper in an ink-jet printer.

2. Description of the Related Art

A feeding roller shaft for an ink-jet printer feeds printing paper loaded in a paper-feeding tray into an image formation section disposed within the printer. Such a feeding roller shaft rotates by receiving power from a separate power source when the printer is driven. In that event, it is often impossible to obtain a desired printing result because distorted printing is generated if shaking is rendered to the feeding roller shaft. Therefore, when a feeding roller shaft supporter is designed and constructed, it is required to take the above points into consideration. Furthermore, as resolution of ink-jet printers increases, even fine shaking may have a harmful influence on the printing result. Therefore, it is a requirement to carefully deal with the design of the feeding roller shaft.

FIGS. 1 and 2 schematically illustrate a conventional feeding roller shaft supporter, in which reference numeral 10 denotes a main chassis, 20 denotes a feeding roller shaft, and 30 denotes a maintenance station.

As shown in FIGS. 1 and 2, the main chassis 10 is provided with first to third stationary pieces 11, 12, and 13, in which the first and second stationary pieces rotatably support opposite ends of the feeding roller shaft 20 by way of a first supporting unit 21 comprising first and second bushings 21a and 21b, respectively. In addition, the maintenance section 30 is installed between the second and third stationary pieces 12 and 13.

One end of the feeding roller shaft 20 is provided with a driving gear 22, and an axial position correction unit 23 is provided adjacent to the driving gear 22 to correct the axial position of the feeding roller shaft 20 when it rotates. The axial position correction unit 23 comprises a spring anchoring ring 23a mounted at a position spaced from the position where the driving gear 22 is connected to the feeding roller shaft 20; a spring washer 23b connected to be in contact with the first bushing 21a; and a spring 23c installed between the anchoring ring 23a and the spring washer 23b. The anchoring ring 23a is connected such that the spring 23c is compressively contracted by the anchoring ring 23a.

The feeding roller shaft 20, which is rotatably supported by the feeding roller shaft supporter, as mentioned above, transfers paper into an image formation section disposed within the ink-jet printer while the feeding roller shaft 20 is being rotated by a driving force, supplied via the driving gear 22, when the ink-jet printer is driven.

However, the feeding roller shaft supporter of the conventional ink-jet printer has a problem in that shaking is rendered to the feeding roller shaft 20 by the thrust generated when the feeing roller shaft 20 rotates, because the feeding roller shaft 20 is simply supported by the first and second stationary pieces 11 and 12 at its opposite ends. In addition, the feeding roller supporter has a problem in that the precision of the gear additionally provides a cause of shaking of the feeding roller shaft 20 because the driving gear 22 is closely contacted with the first supporting unit 21, being positioned adjacent to the first supporting unit 21. If the feeding roller shaft is axially shaken as such, distorted printing is caused, and high-density printing is rendered difficult as a result. Therefore, the prevention of the axial shaking of the feeding roller shaft caused by thrust when the feeding roller shaft rotates is required.

### SUMMARY OF THE INVENTION

Accordingly, the present invention has been made to solve the above-mentioned and/or other problems occurring in the related art, and an aspect of the present invention is to provide a feeding roller shaft supporter for an ink-jet printer, which allows a user to obtain a printing result with a desired high resolution by preventing the axial shaking of the feeding roller shaft when the shaft rotates, so that the distortion occurring during printing on paper, which is caused by the shaking of the feeding roller shaft, can be avoided.

Additional aspects and/or advantages of the invention will be set forth in part in the description which follows and, in part, will be obvious from the description, or may be learned by practice of the invention.

In order to achieve the above and/or other aspects, according to the present invention, there is provided a feeding roller shaft supporter for an ink-jet printer having a feeding roller shaft, which comprises: a main chassis which forms a frame of an ink-jet printer; a first supporting unit in the main chassis supporting opposite ends of the feeding roller shaft; a driving member provided at a first end of the feeding roller shaft; an axial position correction unit mounted on the feeding roller shaft close to the driving member, correcting an axial position of the feeding roller shaft; and a second supporting unit supporting the feeding roller shaft, wherein the second supporting unit is provided on a second end of the feeding roller shaft, preventing the shaking of the feeding roller shaft caused by thrust when the feeding roller shaft rotates.

According to an embodiment of the present invention, the first supporting unit may comprise first and second bushings, the first and second bushings respectively located at opposite ends of the feeding roller shaft.

In addition, a predetermined interval may be formed between the driving member and the first supporting unit at the first end of the feeding roller shaft, so that the driving member does not come into contact with the first supporting unit.

And, the second supporting unit may comprise an anchoring ring and a washer centered about the feeding roller shaft, in which the second supporting unit may be provided to be in face-contact with a surface of the first supporting unit facing the first end of the feeding roller shaft.

According to another embodiment of the present invention, the second supporting unit may comprise a cap provided distally from the second end of the feeding roller shaft, and the cap is in point-contact with a fixed body inside the main chassis.

According to yet another embodiment of the present invention, the second supporting unit may comprise: a cap provided at the second end of the feeding roller shaft; and a cap supporting member, the cap being in point-contact with the cap supporting member, wherein the cap supporting member is assembled to the main chassis or a fixed body inside the main chassis in a screw connection manner so that an extension of the cap supporting member is adjustable.

### BRIEF DESCRIPTION OF THE DRAWINGS

These and/or other aspects and advantages of the invention will become apparent and more readily appreciated from the following description of the preferred embodiments, taken in conjunction with the accompanying drawings of which:

FIG. 1 is a perspective view which schematically illustrates a conventional feeding roller shaft supporter for an inkjet printer;

FIG. 2 is a cross-sectional view of the feeding roller shaft supporter shown in FIG. 1;

FIG. 3 is an exploded perspective view which illustrates a main part of the feeding roller shaft supporter for an ink-jet printer according to an embodiment of the present invention;

FIG. 4 is a cross-sectional view which illustrates the assembled state of the feeding roller shaft supporter shown in FIG. 3;

FIG. 5 is a perspective view which illustrates the state in which the feeding roll shaft is installed in a printer by way of the feeding roller shaft supporter according to the embodiment of the present invention shown in FIG. 3;

FIG. 6 is an exploded perspective view which illustrates a main part of the feeding roller shaft supporter for an ink-jet printer according to another embodiment of the present invention;

FIG. 7 is a cross-sectional view which illustrates the assembled state of the feeding roller shaft supporter shown in FIG. 6;

FIG. 8 is an exploded perspective view which illustrates a main part of the feeding roller shaft supporter for an ink-jet printer according to yet another embodiment of the present invention;

FIG. 9 is a cross-sectional view which illustrates the assembled state of the feeding roller shaft supporter shown in FIG. 8; and

FIG. 10 is a perspective view which illustrates the state in which the feeding roller shaft is installed in a printer by way of the feeding roller shaft supporter according to still another embodiment of the present invention.

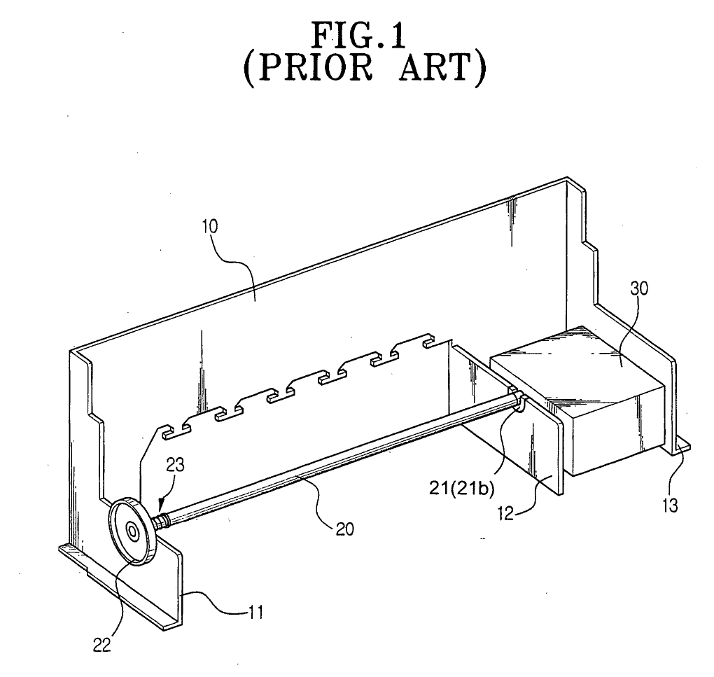

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to the like elements throughout. The embodiments are described below in order to explain the present invention by referring to the figures.

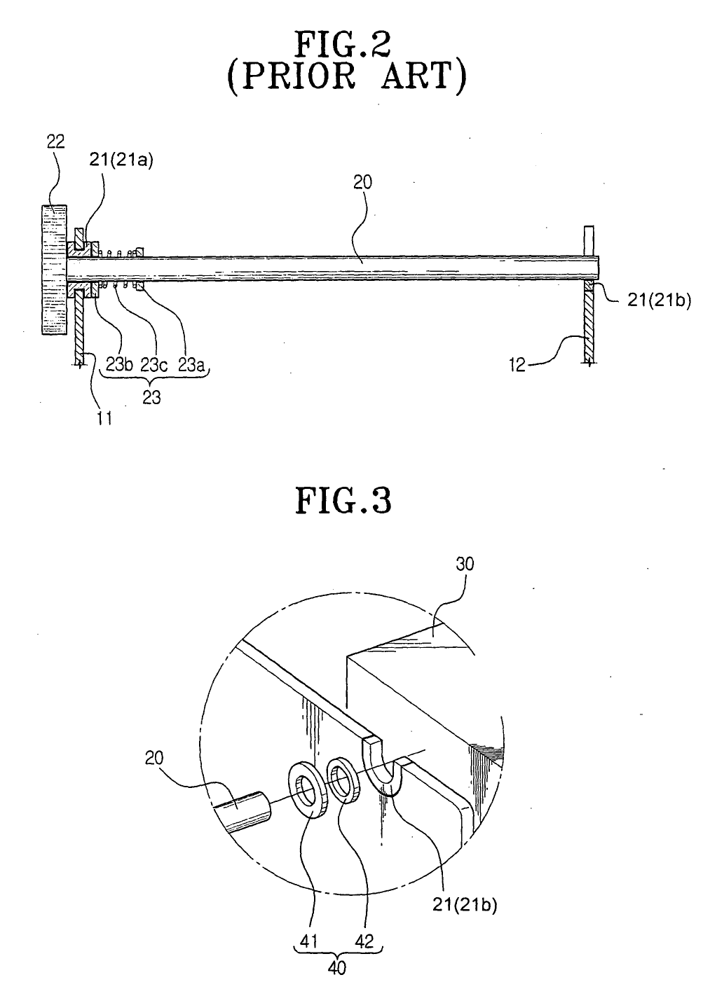

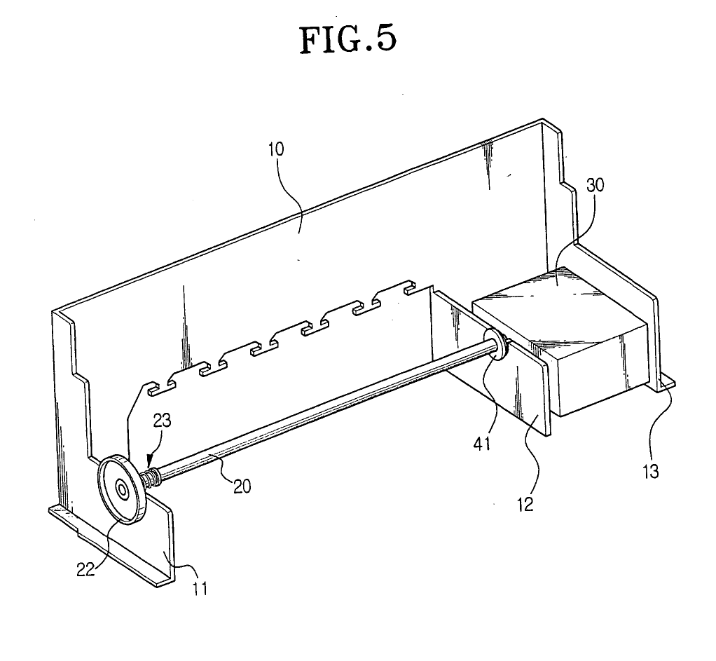

Referring to FIGS. 3 to 5, reference numeral 10 denotes a main chassis, 20 denotes a feeding roller shaft, 21 denotes a first supporting unit, 21a and 21b denote first and second bushings, respectively, 30 denotes a maintenance station, and 40 denotes a second supporting unit.

FIGS. 3 to 5 show an embodiment of the present invention, in which the main chassis 10 is provided with first to third stationary pieces 11, 12 and 13 which are spaced from each other.

The feeding roller shaft 20 is supported by the first and second stationary pieces 11 and 12 in the opposite ends thereof by way of the first supporting unit 21. Further, a driving gear 22 is engaged with an end of the feeding roller shaft 20, in which the driving gear 22 is provided with power from a power source, which is not shown. The driving gear engaged end is provided with an axial position correction unit 23 to correct the axial position of the feeding roller shaft 20 when the feeding roller shaft 20 rotates.

The first supporting unit 21 comprises a first bushing 21a supporting the driving gear engaged end of the feeding roller shaft 20, and a second bushing 21b supporting the other end of the feeding roller shaft 20.

The axial position correction unit 23 comprises a spring anchoring ring 23a mounted at a location spaced from the position where the driving gear 22 is engaged with the feeding roller shaft 20; a spring washer 23b connected to be in contact with the first bushing 21a; and a spring 23c installed between the anchoring ring 23a and the spring washer 23b. The anchoring ring 23a is connected such that the spring 23c is compressively contracted by the anchoring ring 23a.

The maintenance station 30 is installed between the second and third stationary pieces 12 and 13.

The second supporting unit 40 supports the feeding roller shaft 30 on an end of the feeding roller shaft 20 opposite of the axial position correction unit 23, in order to prevent the feeding roller shaft from being shaken by thrust when the feeding roller shaft 20 rotates. The second supporting unit 40 comprises an anchoring ring 41 and a washer 42, and is fitted on the feeding roller shaft 20. In that event, the anchoring ring 41 and the washer 42 are mounted to be in face-contact with the second bushing 21b on the inner surface of the second bushing 21b, thereby increasing the axial supporting points for the feeding roller shaft 20, so that the shaking of the feeding roller shaft can be prevented when the feeding roller shaft rotates.

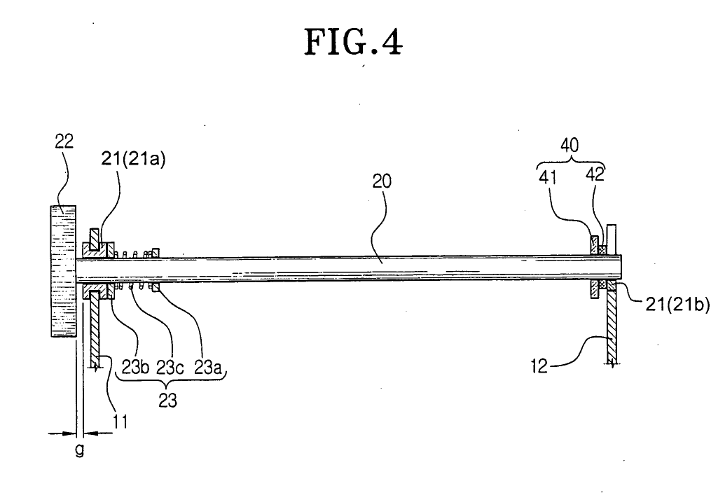

Meanwhile, the feeding roller shaft supporter comprises a gap g with a predetermined size, which is formed between the driving gear 22 and the first bushing 21a, as shown in FIG. 4. Therefore, the driving gear 22 and the first bushing 21a do not come into contact with each other, as a result of which it is possible to avoid one cause of the axial shaking of the feeding roller shaft 20 caused by the contact between the driving gear 22 and the first bushing 21a due to a deviation in the precision of the driving gear 22.

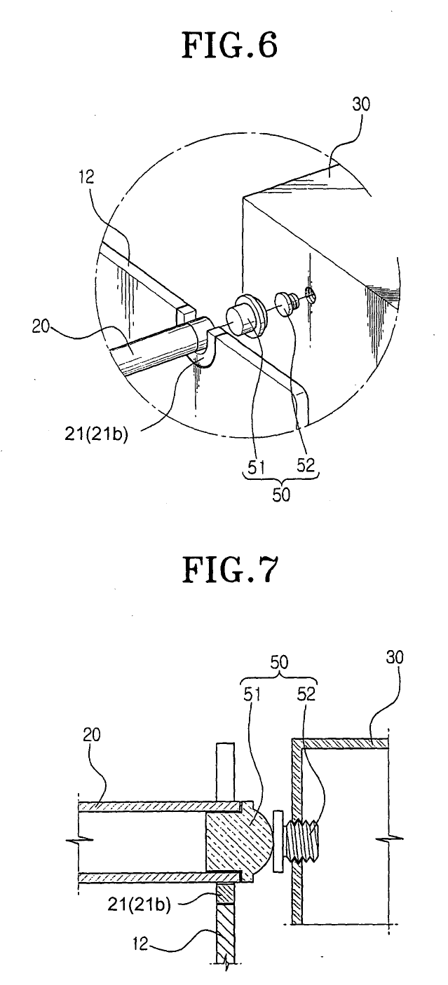

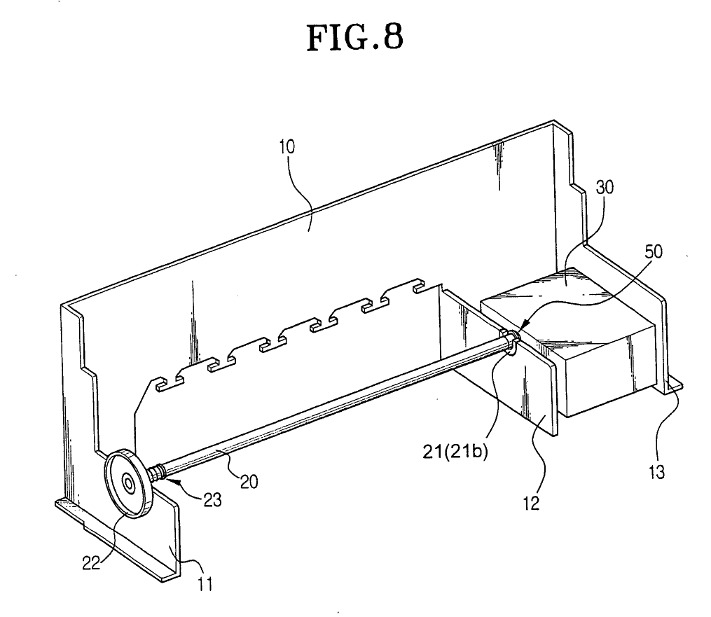

FIGS. 6 to 10 illustrate two more embodiments of the present invention, in which reference numeral 10 denotes a main chassis, 20 denotes a feeding roller shaft, 21 denotes a first supporting unit, 21a and 21b denote first and second bushings, respectively, 30 denotes a maintenance station, and 50 denotes a second supporting unit.

The main chassis 10 is provided with first to third stationary pieces 11, 12 and 13, which are spaced from each other.

The feeding roller shaft 20 is supported by the first and second stationary pieces 11 and 12 on the opposite ends thereof by way of the first supporting unit 21. Further, a driving gear 22 is engaged with an end of the feeding roller shaft 20, in which the driving gear 22 receives power from a power source, which is not shown. The driving gear engaged end is provided with an axial position correction unit 23 to correct the axial position of the feeding roller shaft 20 when the feeding roller shaft 20 rotates.

The first supporting unit 21 comprises a first bushing 21a for supporting the driving gear engaged end of the feeding roller shaft 20; and a second bushing 21b for supporting the other end of the feeding roller shaft 20.

The axial position correction unit 23 comprises a spring anchoring ring 23a mounted at a location spaced from the position where the driving gear 22 is engaged with the feeding roller shaft 20; a spring washer 23b connected to be in contact with the first bushing 21a; and a spring 23c installed between the anchoring ring 23a and the spring washer 23b. The anchoring ring 23a is connected such that the spring 23c is compressively contracted by the anchoring ring 23a.

The maintenance station 30 is installed between the second and third stationary pieces 12 and 13.

As shown in FIGS. 6 through 8, the second supporting unit 50, according to another embodiment of the present invention, comprises a cap 51 inserted into an end of the feeding roller shaft 20, and provided with a rounded external surface; and a cap supporting member 52 connected to a side wall of the maintenance station 30 in a screw connection manner. The cap 51 is arranged in such a way that its rounded external surface is in point-contact with the cap supporting member 52.

Because the second supporting unit 50, as described above, increases the axial supporting part for the feeding roller shaft 20, the shaking of the feeding roller shaft can be prevented when the feeding roller shaft 20 rotates.

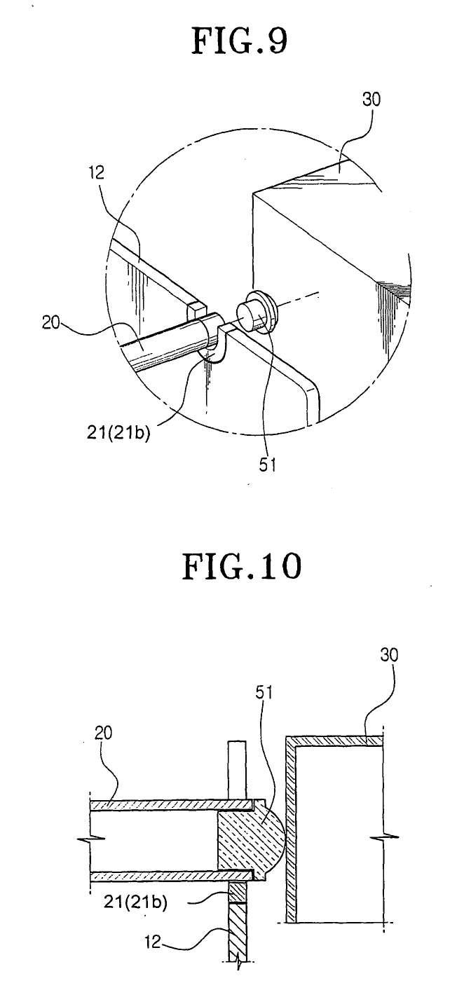

Meanwhile, the supporting unit 50 according to yet another embodiment of the present invention can be constructed with only the cap 51, as shown in FIGS. 9 and 10. In that event, the rounded external surface of the cap 51 is directly in point-contact with a sidewall of the maintenance station 30. As a result, the supporting points for the feeding roller in this embodiment also increase, and thus it is possible to obtain the functional effects as in the previous embodiment.

However, by constructing the supporting unit 50 from the cap 51 and the cap supporting member 52 as in the previous embodiment, additional effects can be obtained along with the prevention of shaking of the feeding roller shaft.

For example, if the cap supporting member 52 is added, the gap g formed between the driving gear 22 and the first bushing 21a (see FIG. 4) can be more efficiently maintained than in the originally presented embodiment, so that the driving gear 22 and the first bushing 21a do not come into direct contact with each other. In particular, it is beneficial to properly maintain the gap g because the shaking of the feeding roller may increase due to the flexure and deviation in flatness of the driving gear 22 and the first bushing 21a if these components come into direct contact. If the cap supporting member 52 is provided, and assembled to the wall of the maintenance station 30 to support the cap 51 in the screw connection manner, it is possible to maintain and/or adjust the gap g by adjusting the extension amount of the cap supporting member 52.

The feeding roller shaft 20, rotatably supported on the main chassis 10 by the feeding roller shaft supporter constructed as described above, is rotationally driven by the power transmitted through the driving gear 22 to feed paper into the image formation section within the printer. In that event, the feeding roller shaft 20 is supported and rotated by the second supporting unit 40 at a definite point; and it is possible to prevent the axial shaking of the feeding roller shaft. Therefore, the distortion of printing on paper caused by the axial shaking of the feeding roller shaft can be avoided, and thus it is possible to obtain a printing result with the desired resolution from a high-density printer.

In the illustrated embodiments, the cap 51 has a rounded external surface and the cap supporting member 52, which is in point-contact with the cap 51, is formed flat. However, the present invention is not limited to such a construction, and the cap 51 and cap supporting member 52 may take any other form being in point-contact with each other. For example, the external surface of the cap 51 may take a cylindrical shape with a flat end face, while the cap supporting member 52 may take a rounded shape.

In addition, the frictional force generated between the cap 51 and the cap supporting member 52 can be minimized in the embodiment described above because the cap 51 and the cap supporting member 52 are arranged to be in point-contact, whereby it is possible to avoid the excessive loss of rotational force of the feeding roller shaft 20 due to the frictional force.

As described above, according to these embodiments of the present invention, additional support for supporting an end of the feeding roller shaft is provided, so that the supporting force can be axially applied to the feeding roller shaft. Consequently, the distortion of printing on paper caused by the axial shaking of the feeding roller shaft can be avoided, and thus it is possible to obtain a printing result with the desired resolution from a high-density printer.

Furthermore, because the driving gear is spaced with a predetermined interval from the first bushing for supporting the feeding roller shaft, it is possible to prevent the feeding roller shaft from being shaken due to a deviation in the precision of the driving gear, whereby the reliability of the resultant product can be enhanced.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A feeding roller shaft supporter for an inkjet printer having a feeding roller shaft, comprising:
a main chassis which forms a frame of an ink-jet printer;
a first supporting unit in the main chassis supporting opposite ends of the feeding roller shaft;
a driving member provided at a first end of the feeding roller shaft;
an axial position correction unit mounted on the feeding roller shaft close to the driving member, correcting an axial position of the feeding roller shaft; and
a second supporting unit supporting the feeding roller shaft, wherein the second supporting unit is provided on a second end of the feeding roller shaft, preventing the shaking of the feeding roller shaft caused by thrust when the feeding roller shaft rotates.

2. The feeding roller shaft supporter according to claim 1, wherein the first supporting unit comprises first and a second bushings, the first and second bushings respectively located at opposite ends of the feeding roller shaft.

3. The feeding roller shaft supporter according to claim 2, wherein a predetermined interval is formed between the driving member and the first supporting unit at the first end of the feeding roller shaft, so that the driving member does not come into contact with the first supporting unit.

4. The feeding roller shaft supporter according to claim 1, wherein a predetermined interval is formed between the driving member and the first supporting unit at the first end of the feeding roller shaft, so that the driving member does not come into contact with the first supporting unit.

5. The feeding roller shaft supporter according to claim 1, wherein the second supporting unit comprises an anchoring ring and a washer centered about the feeding roller shaft.

6. The feeding roller shaft supporter according to claim 5, wherein the second supporting unit is provided to be in face-contact with a surface of the first supporting unit facing the first end of the feeding roller shaft.

7. The feeding roller shaft according to claim 1, wherein the second supporting unit comprises a cap provided distally from the second end of the feeding roller shaft, and the cap is in point-contact with a fixed body inside the main chassis.

8. The feeding roller shaft supporter according to claim 7, wherein a predetermined interval is formed between the driving member and the first supporting unit at the first end of the feeding roller shaft, so that the driving member does not come into contact with the first supporting unit.

9. The feeding roller shaft according to claim 7, wherein the cap is inserted into the second end of the feeding roller shaft.

10. The feeding roller shaft according to claim 7, wherein the cap has a rounded external surface.

11. The feeding roller shaft according to claim 7, wherein the fixed body inside the main chassis is a maintenance station.

12. The feeding roller shaft according to claim 1, wherein the second supporting unit comprises:
a cap provided at the second end of the feeding roller shaft; and
a cap supporting member, the cap being in point-contact with the cap supporting member,
wherein the cap supporting member is assembled to the main chassis or a fixed body inside the main chassis in a screw connection manner so that an extension of the cap supporting member is adjustable.

13. The feeding roller shaft supporter according to claim 12, wherein a predetermined interval is formed between the driving member and the first supporting unit at the first end of the feeding roller shaft, so that the driving member does not come into contact with the first supporting unit.

14. The feeding roller shaft according to claim 12, wherein the cap is provided with a rounded external surface, and the rounded external surface is in point-contact with a flat surface of the cap supporting member.

15. The feeding roller shaft according to claim 12, wherein the cap supporting member is provided with a rounded external surface, and the rounded external surface is in point-contact with the cap.

16. A method of supporting a feeding roller shaft for an ink-jet printer to reduce shaking of the shaft occurring with the rotation of the feeding roller shaft, the method comprising:
providing a first supporting unit, in a main chassis of the printer, supporting opposite ends of the feeding roller shaft in a radial direction;
providing an axial position correction unit on a first end of the feeding roller shaft, close to a driving member; and
providing a second supporting unit on a second end of the feeding roller shaft, supporting the feeding roller shaft in an axial direction.

17. The method of claim 16, further comprising forming a predetermined interval between the driving member and the first supporting unit at the first end of the feeding roller shaft, so that the driving member does not come into contact with the first supporting unit.

18. The method of claim 16, wherein the providing a second supporting unit comprises providing an anchoring ring and a washer to be in contact with the first supporting unit.

19. The method of claim 16, wherein the providing a second supporting unit comprises providing a cap to be in contact with a fixed body inside the main chassis.

20. The method of claim 16, wherein the providing a second supporting unit comprises:
providing a cap on the second end of the feeding roller shaft; and
providing a cap supporting member to be in point contact with the cap;
wherein the cap supporting member is assembled to the main chassis or a fixed body inside the main chassis in a screw connection manner so that an extension of the cap supporting member is adjustable.

21. A feeding roller shaft supporter for an ink-jet printer having a feeding roller shaft, comprising:
a first supporting unit supporting opposite ends of the feeding roller shaft in a radial direction;
a driving member provided at a first end of the feeding roller shaft; and
a second supporting unit provided on a second end of the feeding roller shaft, supporting the feeding roller shaft in an axial direction, so that axial shaking of the feeding roller shaft is reduced.

22. The feeding roller shaft supporter of claim 21, wherein the second supporting unit is provided to be in point-contact with the first supporting unit or a fixed body in the printer, so that friction affecting a rotational force of the feeding roller shaft by the contact is reduced.

23. The feeding roller shaft supporter of claim 21, further comprising a predetermined interval between the driving member and the first supporting unit at the first end of the feeding roller shaft.

24. A feeding roller shaft supporter for an ink-jet printer having a feeding roller shaft, comprising:
a first supporting unit supporting opposite ends of the feeding roller shaft;
a driving member provided at a first end of the feeding roller shaft; and
a predetermined interval between the driving member and the first supporting unit at the first end of the feeding roller shaft, the predetermined interval preventing the feeding roller shaft from being shaken due to deviation in the driving member.
